(19) United States
(12) Patent Application Publication
(10) Pub. No.: US 2010/0046950 A1
(43) Pub. Date: Feb. 25, 2010

(54) SEEDING WDM PON SYSTEM BASED ON QUANTUM DOT MULTI-WAVELENGTH LASER SOURCE

(75) Inventors: Bin CAO, Kanata (CA); Claude ROLLAND, Ottawa (CA)

Correspondence Address: KED & ASSOCIATES, LLP, P.O. Box 221200, Chantilly, VA, 20153-1200, US

(73) Assignee: NORTEL NETWORKS LIMITED, St.Laurent (CA)

(21) Appl. No.: 12/480,803

(22) Filed: Jun. 9, 2009

Related U.S. Application Data
(63) Continuation-in-part of application No. 12/341,102, filed on Dec. 22, 2008.
(60) Provisional application No. 61/090,644, filed on Aug. 21, 2008.

(51) Int. Cl. H04J 14/02

(52) U.S. Cl. 398/79

(57) ABSTRACT

A seed light source for use in Wavelength Division Multiplexed Passive Optical Network (WDM-PON) includes a multi-channel quantum dot laser for generating a multi-channel seed light comprising a plurality of respective channel seed lights. Each channel seed light corresponds to a respective channel of the WDM-PON.

### CROSS-REFERENCE TO RELATED APPLICATIONS

This application is based on, and claims priority from, U.S. Provisional Patent Application Ser. No. 61/090,644, filed Aug. 21, 2008, the entire contents of which are incorporated herein by reference. This application is a Continuation in Part of U.S. patent application Ser. No. 12/341,012 filed Dec. 22, 2008, the entire contents of which are incorporated herein by reference.

### FIELD OF THE INVENTION

The present application relates generally to Wavelength Division Multiplexed Passive Optical Networks (WDM PON) and, more specifically, to seeding a WDM PON system using a quantum dot multi-wavelength laser source

### BACKGROUND OF THE INVENTION

A passive optical network (PON) is a point-to-multipoint network architecture in which unpowered optical splitters are used to enable a single optical fibre to serve multiple premises. A PON typically includes an Optical Line Terminal (OLT) at the service provider's central office connected to a number (typically 32-128) of Optical Network Terminals (ONTs), each of which provides an interface to customer equipment.

In operation, downstream signals are broadcast from the OLT to the ONTs on a shared fibre network. Various techniques, such as encryption, can be used to ensure that each ONT can only receive signals that are addressed to it. Upstream signals are transmitted from each ONT to the OLT, using a multiple access protocol, such as time division multiple access (TDMA), to prevent “collisions”.

A Wavelength Division Multiplexing PON, or WDM-PON, is a type of passive optical network in which multiple optical wavelengths are used to increase the upstream and/or downstream bandwidth available to end users. FIG. 1 is a block diagram illustrating a typical WDM-PON system.

As may be seen in FIG. 1, the OLT 4 comprises a plurality of transceivers 6, each of which includes a light source 8 and a detector 10 for sending and receiving optical signals on respective wavelength channels, and an optical combiner/splitter 12 for combining light from/to the light source 8 and detector 10 onto a single optical fibre 14. The light source 8 may be a conventional laser diode such as, for example, a distributed feed-back (DFB) laser, for transmitting data on the desired wavelength using either direct laser modulation, or an external modulator (not shown) as desired. The detector 10 may, for example, be a PIN diode for detecting optical signal received through the network. An optical mux/demux 16 (such as, for example, a Thin-Film Filter—TFF) is used to couple light between each transceiver 6 and an optical fibre trunk 18, which may include one or more passive optical power splitters (not shown).

A passive remote node 20 serving one or more customer sites includes an optical mux/demux 22 for demultiplexing wavelength channels from the optical trunk fibre 18. Each wavelength channel is then routed to an appropriate branch port 24 which supports a respective WDM-PON branch 26 comprising one or more Optical Network Terminals (ONTs) 28 at respective customer premises. Typically, each ONT 28 includes a light source 30, detector 32 and combiner/splitter 34, all of which are typically configured and operate in a manner mirroring that of the corresponding transceiver 6 in the OLT 4.

Typically, the wavelength channels of the WDM-PON are divided into respective channel groups, or bands, each of which is designated for signalling in a given direction. For example, C-band (e.g. 1530-1565 nm) channels may be allocated to uplink signals transmitted from each ONT 28 to the OLT 4, while L-band (e.g. 1565-1625 nm) channels may be allocated to downlink signals from the OLT 4 to the ONT(s) 26 on each branch 26. In such cases, the respective optical combiner/splitters 12,34 in the OLT transceivers 6 and ONTs 28 are commonly provided as passive optical filters well known in the art.

The WDM-PON illustrated in FIG. 1 is known, for example, from “Low Cost WDM PON With Colorless Bidirectional Transceivers”, Shin, D J et al, Journal of Lightwave Technology, Vol. 24, No. 1, January 2006. With this arrangement, each branch 26 is allocated a predetermined pair of wavelength channels, comprising an L-band channel for downlink signals transmitted from the OLT 4 to the branch 26, and a C-band channel for uplink signals transmitted from the ONT(s) 28 of the branch 26 to the OLT 4. The MUX/DEMUX 16 in the OLT 4 couples the selected channels of each branch 26 to a respective one of the transceivers 6. Consequently, each transceiver 6 of the ONT is associated with one of the branches 26, and controls uplink and downlink signalling between the OLT 4 and the ONT(s) 28 of that branch 26. Each transceiver 6 and ONT 28 is rendered “colorless”, by using reflective light sources 8, 30, such as reflective semi-conductor optical amplifiers (RSOAs); injection-locked Fabry-Perot lasers; reflective electro-absorptive modulators; and reflective Mach-Zehnder modulators. With this arrangement, each light source 8, 30 requires a respective “seed” light which is used to produce the corresponding downlink/uplink optical signals. In the system of FIG. 1, the seed light for downlink signals is provided by an L-band seed light source (SLS-L) 36 via an L-band optical circulator 38. Similarly, the seed light for uplink signals is provided by a C-band seed light source (SLS-C) 40 via a C-band optical circulator 42.

As may be seen in FIGS. 2a and 2b, each of the seed light sources (SLSs) 36, 40 may be constructed in a variety of different ways. In the SLS of FIG. 2a, a set of narrow-band lasers 44 are used to generate respective narrow band seed lights 46, each of which is tuned to the center wavelength of a respective channel of the WDM-PON. A multiplexer 48 combines the narrow-band seed lights 46 to produce a WDM seed light 50, which is then distributed through the WDM-PON to either the ONTs 26 (in the case of C-band seed light) or the transceivers 6 (in the case of L-Band seed light). If desired, each of the narrow-band lasers 44 may be provided as conventional bulk semiconductor laser diodes.

In the SLS of FIG. 2b, the seed light source (SLS) is provided by a continuous broadband light source (BLS) 52 such as a Superluminescent Light Emitting Diode (SLED) or an Amplified Spontaneous Emission (ASE) source (such as an optical amplifier) that produces a continuous spectrum of light across a wide range of wavelengths. A comb filter 54 generates the desired WDM seed light 50 by filtering the continuous spectrum light emitted by the BLS 52.

In both of the SLSs of FIGS. 2a and 2b, an optical amplifier 58 (for example an Erbium Doped Fiber Amplifier (EDFA)) can be used to amplify the WDM seed light 50. This arrangement is useful for increasing link budget (and thus signal reach).

The system of FIGS. 1 and 2 is advantageous in that the light sources 8, 30 are colorless. As a result, a common transceiver configuration can be used for every channel, which facilitates reduced costs via economies of scale. However, in WDM PON systems in which narrow-band lasers 44 are used to generate respective narrow band seed lights 46, as described above with reference to FIG. 2a, the costs of the C-band and L-band SLSs 36, 40 may at least partially offset the cost savings obtained by using colorless transceivers. The use of a filtered broadband light source for generating the seed lights (as described with reference to FIG. 2b) lowers the cost of the C-band and L-band SLSs 36, 40, but lowers the seeding efficiency because much of the optical power generated by the BLS 52 is lost in the filter 56, and results in increased relative intensity noise (RIN) in the output seed light 50. In addition, filtering a broadband light source 52 to produce individual channel seed lights means that the band-width of each channel seed light is determined by the filter function of the comb filter 56. Typically, this will result in channel seed lights of increased band width, as compared to the use of semiconductor laser seed light sources 44, which induces increased noise in the channel signal output by an injection-locked or reflective light source 8, 30 due to heterodyne interference between the seed light and the channel signal.

### SUMMARY OF THE INVENTION

An aspect of the present invention provides, in a Wavelength Division Multiplexed Passive Optical Network (WDM-PON), a seed light source includes a multi-channel quantum dot laser for generating a multi-channel seed light comprising a plurality of respective channel seed lights. Each channel seed light corresponds to a respective channel of the WDM-PON.

### BRIEF DESCRIPTION OF THE DRAWINGS

Further features and advantages of the present invention will become apparent from the following detailed description, taken in combination with the appended drawings, in which:

FIGS. 1a and 1b schematically illustrate a conventional WDM-PON known in the prior art;

FIGS. 2a and 2b schematically illustrate respective conventional broadband light sources that may be used to general seed light in the WDM-PON of FIG. 1;

FIGS. 3a-3d schematically illustrate elements and principal operations of a seed light source in accordance with a representative embodiment of the present invention; and

FIG. 4 schematically illustrates an Optical Network Terminal of a WDM-PON incorporating the seed light source of FIGS. 3a-d.

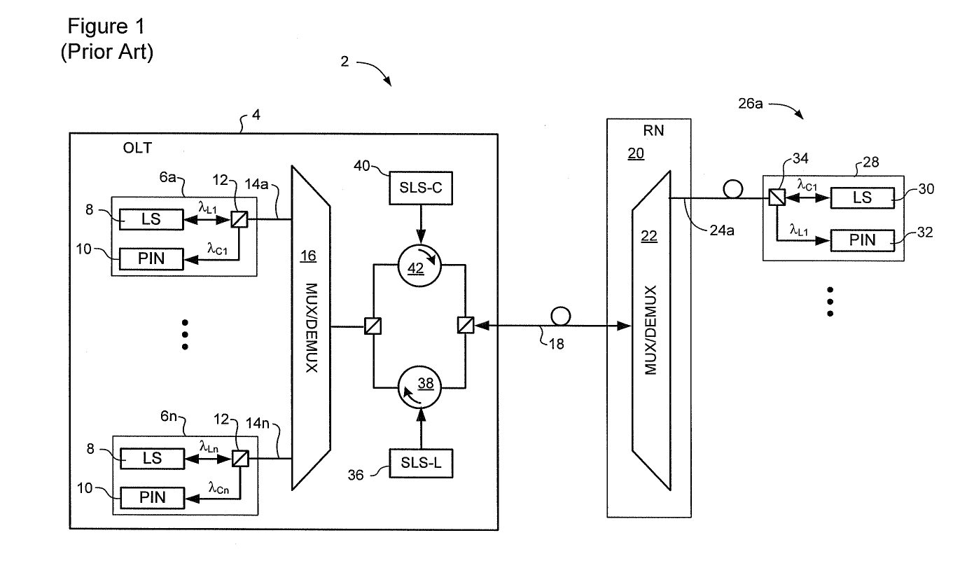

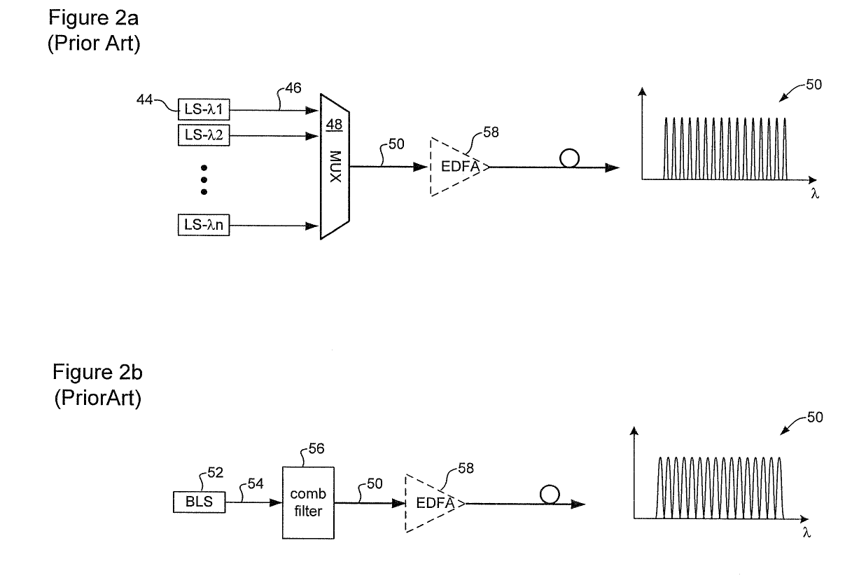

It will be noted that throughout the appended drawings, like features are identified by like reference numerals.

### DETAILED DESCRIPTION OF PREFERRED EMBODIMENTS

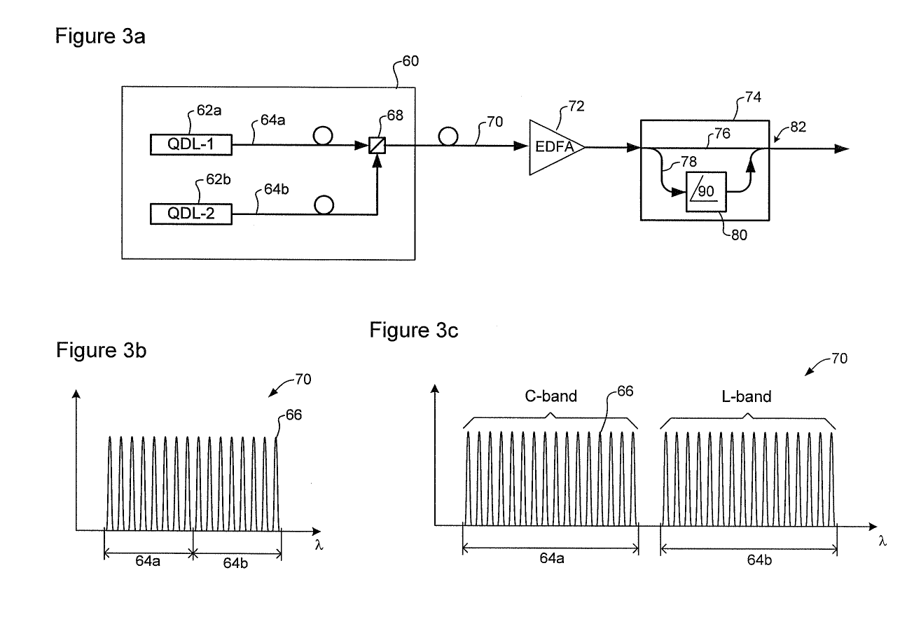

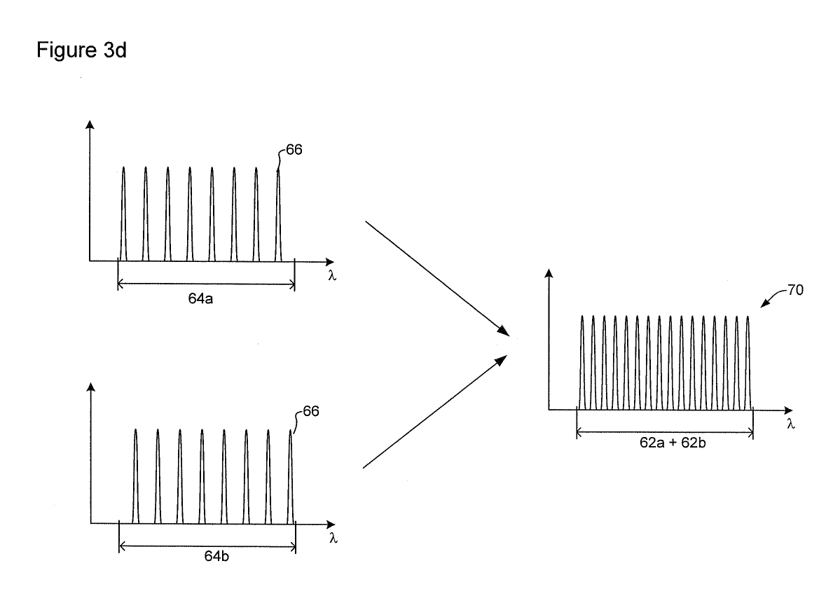

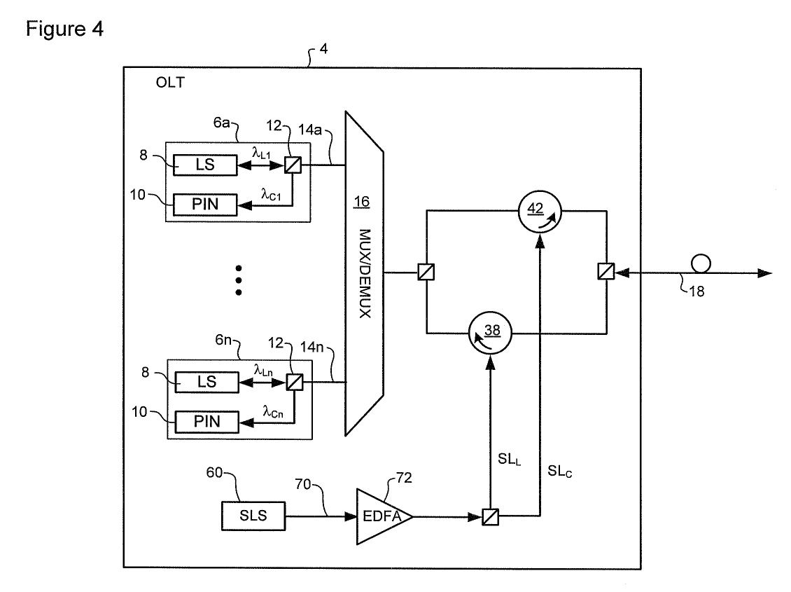

The present invention provides techniques for seeding a Wavelength Division Multiplexing Passive Optical Network (WDM-PON). A representative embodiment is described below with reference to FIGS. 3-4.

Referring to FIGS. 3-4, in very general terms, a seed light source utilizes one or more multi-channel quantum dot lasers to generate a WDM seed light for seeding a WDM-PON system. Multi-channel quantum dot based lasers are known in the art. Conveniently, the output spectrum of a Multi-channel quantum dot laser, including the number of channels, and the center wavelength and bandwidth of each channel, can be controlled by the design and construction of the quantum dot laser unit. If desired, known techniques can be used to improve stability of the quantum dot laser, and so reduce jitter in the center wavelength of each channel. For example, known feedback control loop techniques can be used to control temperature and laser drive current to maintain the laser output spectrum within predefined tolerances.

FIG. 3a illustrates a representative embodiment of a Seed Light Source (SLS) 60 which comprises a pair of multi-channel quantum dot lasers 62. Each laser 62 generates a respective multi-channel seed light 64 which comprises a set of narrow band channel seed lights 66 (FIG. 3b) corresponding to respective channels of the WDM PON. The multi-channel seed lights 64 are combined using a passive optical combiner 68 to generate a WDM seed light 70. The optical combiner 68 may, for example, be a passive filter based combiner known in the art, although other suitable optical combiner devices may be used, if desired.

In some embodiments, a single multi-channel single quantum dot laser 62 may be used to generate a WDM seed light 70 encompassing respective channel seed lights 66 for all of the channels of the WDM-PON In such cases, the combiner 68 will clearly not be needed. In other embodiments, two or more lasers 62 may be used, each of which generates a respective multi-channel seed light 64 encompassing a set of channel seed lights 66 corresponding to a respective subset of the channels of the WDM-PON, as may be seen in FIG. 3b.

In some embodiments, a single multi-channel quantum dot laser 62 may be used to generate a respective multi-channel seed light 64 encompassing all of the channel seed lights 66 of a given channel band. For example, in the embodiment of FIG. 3c, the multi-channel seed light 64a generated by multi-channel quantum dot laser 62a encompasses channel seed lights 66 for all of the C-band channels, and the multi-channel seed light 64b generated by multi-channel quantum dot laser 62b encompasses channel seed lights 66 for all of the L-band channels. In still other embodiments, two or more multi-channel quantum dot lasers 62 may be used for each channel band, if desired.

In cases where two (or more) multi-channel quantum dot lasers 62 are used to generate seed lights of a given channel band of the WDM-PON, each multi-channel quantum dot laser 62 can be constructed to generate seed lights for a respective set of adjacent channels, as shown in FIG. 3b. However, is some cases it may be preferable to design each multi-channel quantum dot laser 62 to generate seed lights for interleaving sets of channels. For example, FIG. 3d shows an embodiment in which multi-channel seed light 64a comprises channel seed lights for odd-numbered channels, and multi-channel seed light 64b comprises channel seed lights for even-numbered channels. This later arrangement may reduce relative intensity noise (RIN) in the output spectra of each multi-channel quantum dot laser 62, by increasing the spectral separation between quantum dot emitters of each laser 62.

In some embodiments, the SLS 60 comprises two or more multi-channel quantum dot lasers 62 within a single integrated package, such as an Application Specific Integrated Circuit (ASIC), for example. This arrangement is beneficial in that it facilitates low-cost manufacturing of the SLS 60. Preferably, the seed lights 64 generated by all of the multi-channel quantum dot lasers 62 within such an integrated package are combined, for example using a suitable optical combiner network, to generate a WDM seed light 70 which is output from the integrated package through a common optical fiber “pig-tail”. This arrangement is beneficial in that it eliminates the need for an optical combiner external to the integrated package, and thereby reduces costs and simplifies integration of the SLS 60 with an OLT 4.

If desired, an optical amplifier 72, for example an Erbium Doped Fiber Amplifier (EDFA), can be used to amplify the WDM seed light 70 at the output of the SLS 60. This arrangement is useful for increasing link budget (and thus signal reach).

As mentioned above, the OLT transceivers 6 and ONTs 28 comprise reflective reflective light sources 8, 30, such as reflective semi-conductor optical amplifiers (RSOAs); injection-locked Fabry-Perot lasers; reflective electro-absorptive modulators; and reflective Mach-Zehnder modulators. As is known in the art, some reflective light sources (for example RSOAs and injection-locked Fabry-Perot lasers) are polarization dependent. However, the seed lights 64 generated by the multi-channel quantum dot lasers 62 tend to be highly polarized. In such situations, the WDM seed light 70 can be depolarized using a depolarizer 74 as shown in FIG. 3a. In the embodiment of FIG. 3a, the depolarizer 74 divides the optical signal path into a through-path 76 and a rotation path 78. Within the rotation path, a polarization rotator 80 (such as, for example, a ¼-wave bi-refringent crystal) is used to rotate the polarization angle by 90-degrees. The two paths 76 and 78 are then combined at the output 82 of the depolarizer 74. As may be appreciated, known passive optical techniques can be used to implement the various elements of the depolarizer 74. When the elements of the through-path 76 and a rotation path 78 are suitably matched, the recombined WDM seed light emerging from the output 82 of the depolarizer 74 will contain equal power contributions from both paths 76 and 78, and thus will be de-polarized.

In FIG. 3a, the depolarizer 74 is shown downstream of the EDFA 72. However, this is not essential. In fact, the depolarizer 74 can be inserted at any desired location in the signal path. For example, in some embodiments, the depolarizer 74 is integrated into the SLS 60 immediately downstream of the signal combiner 68.

FIG. 4 schematically illustrates an OLT 4 incorporating a seed light source 60 in accordance with the present invention. The SLS 60 may be constructed as described above with reference to FIG. 3, and generates a WDM seed light 70 comprising channel seed lights 66 for both of the L-band and C-band channels of the WDM-PON. An optical amplifier 72 amplify the WDM seed light 70 as described above. An optical splitter 74, for example a passive filter-based splitter of a type known in the art is used to separate the L-band and C-band channel seed lights, which are then supplied to the L-band and C-band optical circulators 38 and 42, respectively. The remainder of the OLT 4 is constructed and operates in a conventional manner, and thus will not be further described. As may be seen in FIG. 4, the SLS 60 of the present invention enables a single integrated package to source respective channel seed lights for every channel of the WDM-PON. In so doing, the present invention simplifies integration of seed light sources into the WDM-PON, and reduces costs, as compared to prior art techniques.

The embodiments of the invention described above are intended to be illustrative only. The scope of the invention is therefore intended to be limited solely by the scope of the appended claims.

We claim:

1. In a Wavelength Division Multiplexed Passive Optical Network (WDM-PON), a seed light source comprising:
a multi-channel quantum dot laser for generating a multi-channel seed light comprising a plurality of respective channel seed lights, each channel seed light corresponding to a respective channel of the WDM-PON.

2. The seed light source as claimed in claim 1, wherein the multi-channel seed light comprises respective channel seed lights corresponding to every channel of the WDM-PON.

3. The seed light source as claimed in claim 1, comprising two or more multi-channel quantum dot lasers, each multi-channel quantum dot laser generating a multi-channel seed light comprising respective set of channel seed lights corresponding to a subset of channels of the WDM-PON.

4. The seed light source as claimed in claim 3, further comprising an optical combiner for combining the respective multi-channel seed lights generated by each of the multi-channel quantum dot lasers.

5. The seed light source as claimed in claim 3, wherein the set of channel seed lights of each multi-channel seed light corresponds with a respective set of adjacent channels of the WDM-PON.

6. The seed light source as claimed in claim 3, wherein the respective sets of channel seed lights of at least two multi-channel seed lights correspond with respective interleaving sets of channels of the WDM-PON.

7. The seed light source as claimed in claim 1, further comprising an optical amplifier for amplifying a WDM seed light at an output of the seed light source.

8. The seed light source as claimed in claim 1, further comprising a depolarizer for depolarizing a WDM seed light at an output of the seed light source.
